(19) United States
(12) Patent Application Publication
(10) Pub. No.: US 2011/0296310 A1
(43) Pub. Date: Dec. 1, 2011

(54) DETERMINING WHETHER A COMPOSITE CONFIGURATION ITEM SATISFIES A COMPLIANCE RULE

(76) Inventors: YUVAL CARMEL, Tel Aviv (IL); Ido Ish-Hurwitz, Kfar-Saba (IL); Oded Zilinsky, Yehud (IL); Ary Dvoretz, Ganey Tikva (IL); Doron Tvizer, Yehud (IL); Robert Bitterfeld, Yehud (IL)

(21) Appl. No.: 12/788,459

(22) Filed: May 27, 2010

(51) Int. Cl. G06F 15/177; G06N 5/02

(52) U.S. Cl. 715/735; 706/47

(57) ABSTRACT

At least one selection relating to at least one element of a compliance rule is received through a user interface. The compliance rule is for a composite configuration item that has a collection of configuration items that are related to each other. Each of the configuration items represents a configuration of an information technology component. It is determined whether the composite configuration item satisfies the compliance rule, where the elements of the compliance rule are compared to the corresponding configuration items of the composite configuration item as part of the determining.

### BACKGROUND

An information technology (IT) infrastructure of an enterprise (e.g., a company, an educational organization, a government agency, etc.) can include a wide variety of electronic devices, associated software components, and database components. A configuration item can be employed to define a configuration of an electronic device, and/or a software component and/or a database component. A “configuration” can include an attribute associated with an electronic device (or a portion of the electronic device), an attribute associated with a software component, and/or an attribute associated with a database component.

### BRIEF DESCRIPTION OF THE DRAWINGS

Some embodiments are described with respect to the following figures:

FIG. 1 is a flow diagram of a process of configuration item compliance management, according to some embodiments;

FIG. 2 is a block diagram of an example arrangement including a configuration management system according to some embodiments;

FIG. 3 illustrates an example graphical user interface (GUI) screen presented by the configuration management system according to some embodiments to allow for definition of a baseline configuration item hierarchy;

FIG. 4 illustrates an example GUI screen presented by the configuration management system according to some embodiments for depicting a view of composite configuration items;

FIG. 5 illustrates an example GUI screen depicting details of a breach of a compliance rule, presented by the configuration management system according to some embodiments;

FIG. 6 is a flow diagram of a process of configuration item compliance management, according to further embodiments; and

FIG. 7 illustrates example elements of a composite configuration item to be compared to a baseline configuration item hierarchy, by the configuration management system according to some embodiments.

### DETAILED DESCRIPTION

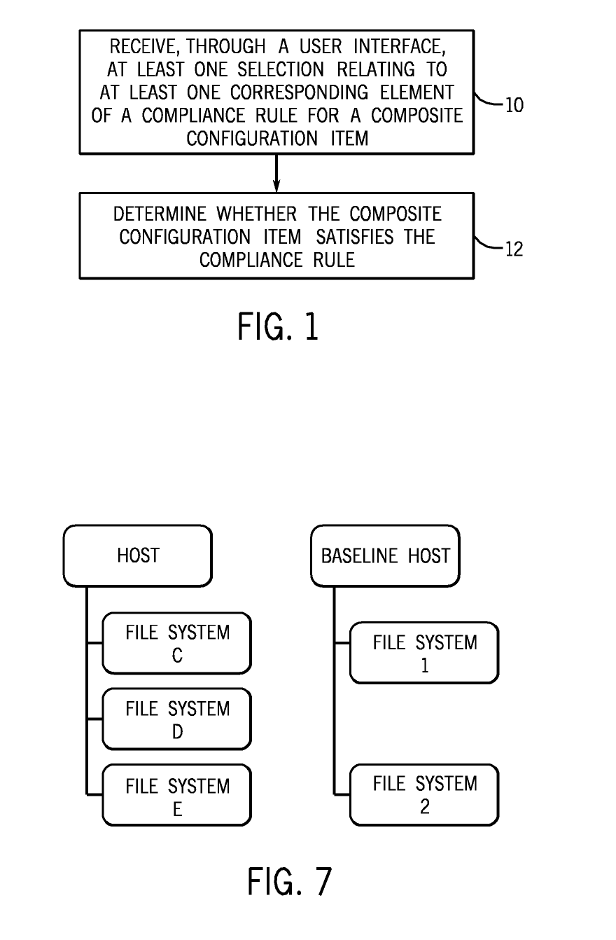

Generally, a configuration management system according to some embodiments is provided to define a compliance rule for a composite configuration item. As depicted in FIG. 1, the configuration management system receives (at 10), through a user interface, at least one selection relating to at least one element of the compliance rule for the composite configuration item. The configuration management system then determines (at 12) whether the composite configuration item satisfies the compliance rule. A composite configuration item is made up of a collection (or bundle) of configuration items. “Composite configuration item” is abbreviated as “composite CI” in the ensuing discussion.

A configuration item represents a discrete unit of a configuration relating to an electronic device (or a portion of an electronic device), a software component, and/or a database component. Examples of electronic devices (or electronic device portions) include computers, storage array systems, memory devices, central processing units (CPUs), communications devices such as routers or switches, personal digital assistants (PDAs), smart telephones, and so forth. Examples of software components include operating systems, device drivers, software applications, file systems, and so forth. Examples of database components include data structures such as databases, tables, files, and so forth, used for storing data. More generally, an electronic device (or electronic device portion), software component, and/or database component is referred to as information technology (IT) component. A configuration of an IT component includes at least one attribute (e.g., speed of CPU, size of file system, type of operating system, etc.) of the IT component.

A composite CI is composed of a collection of configuration items that are related to each other. In some implementations, a composite CI is composed of a main configuration item and internal configuration items of the main configuration item. For example, the main configuration item can be a host system, while the internal configuration items can include the components of the host system, such as a CPU, a file system, an operating system, application software, a storage device, a network protocol stack, and so forth.

In an enterprise with a relatively large number of IT components, it may be relatively difficult for an IT organization to manage or understand configurations of the IT components, and/or to understand causes of problems or other issues (e.g., errors, faults, etc.) associated with the IT components. Some conventional techniques involve development of complex queries to check configurations of IT components, which is time consuming and subject to errors.

By using the configuration management system according to some embodiments, an IT organization of an enterprise (e.g., a company, an educational organization, a government agency, etc.) is able to efficiently validate the correctness of configurations in an IT system made up of configuration items bundled into composite CIs as discussed above. The IT organization is able to easily track whether configuration items are being configured according to corresponding compliance rules. Moreover, a convenient mechanism is provided to locate configuration items that breach a compliance rule.

As some examples, an attribute associated with a configuration item that represents a configuration of an operating system can specify the type of operating system (e.g., Unix, Linux, WINDOWS®, and so forth). An attribute associated with a configuration item representing a CPU can specify a speed or manufacturer of the CPU. An attribute of a configuration item that represents a file system can specify a total size of the file system.

In accordance with some embodiments, a compliance rule that is to be compared to a composite CI has various elements that correspond to the configuration items of the composite CI. The elements of the compliance rule are matched to the configuration items of the composite CI, and attributes associated with the elements of the compliance rule are then compared to attributes of the corresponding matched configuration items. Based on the comparing, the configuration management system according to some embodiments is able to determine (at 12) whether any of the configuration items of the composite CI fails to satisfy (breaches) the compliance rule.

In some implementations, the compliance rule is in the form of a baseline configuration item hierarchy, where such hierarchy includes a hierarchy (or other arrangement) of related configuration items for matching to corresponding configuration items of a composite CI that is being analyzed. The baseline configuration item hierarchy is user-definable. In some implementations, the baseline configuration item hierarchy can be based on a selected “gold” configuration item hierarchy that is known to satisfy the compliance rule. This “gold” configuration item hierarchy is then copied as the baseline configuration item hierarchy, along with the attribute values of the “gold” configuration item. Alternatively, instead of copying the baseline configuration item hierarchy from a “gold” configuration item hierarchy, a user can manually create the baseline configuration item hierarchy by adding configuration items to the hierarchy. In some implementations, a graphical user interface (GUI) is provided to allow the user to define the baseline configuration item hierarchy. As discussed further below, this GUI includes various fields that correspond to the definition of the baseline configuration item hierarchy.

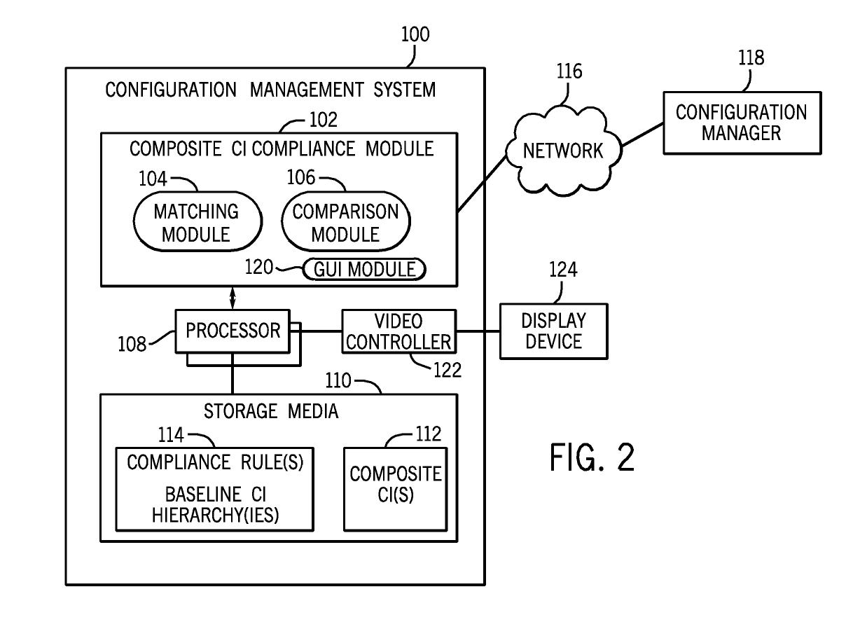

FIG. 2 is a block diagram of an arrangement that incorporates some embodiments. The arrangement of FIG. 2 includes a configuration management system 100 that includes a composite CI compliance module 102 for checking whether a composite CI (112) that is being analyzed satisfies a compliance rule (114), such as according to the process of FIG. 1. The composite CI compliance module 102 includes a matching module 104 and a comparison module 106 (which are discussed further below). The composite CI compliance module 102 can be formed using machine-readable instructions executable on at least one processor 108 in the configuration management system 100. In some implementations, the configuration management system 100 is a computer system (formed of a single computer node or multiple distributed computer nodes) that has corresponding hardware processors on which machine-readable instructions are executable.

The at least one processor 108 is connected to storage media 110, which can be implemented with disk-based storage devices and/or semiconductor memory devices. The storage media 110 contains information accessible by the composite CI compliance module 102. For example, the information stored in the storage media 110 includes at least one composite CI 112 that is to be analyzed for compliance with at least one compliance rule 114 (also stored in the storage media). Each compliance rule 114 can be in the form of a baseline configuration item hierarchy.

In FIG. 2, the configuration management system 100 is coupled over a network 116 (e.g., local area network, wide area network, public network such as the Internet, etc.) to a remote configuration manager 118. The configuration manager 118 can be a remote client device, such as a desktop computer, notebook computer, PDA, or other device associated with a user (such as a system administrator) that is interested in whether composite CIs satisfy corresponding one or plural compliance rules.

Generally, a compliance rule stipulates attribute values associated with configuration items of a composite CI being analyzed. For example, the compliance rule can specify that a host system should have two CPUs (exactly two CPUs or at least two CPUs), a file system, and an operating system. The compliance rule can also specify values of attributes to be satisfied. For example, the compliance rule can specify that the operating system of the host system should be a specific type of operating system (e.g., WINDOWS® operating system), that the speed of the CPU should be at least 3 gigahertz (GHz), and that the total file system size should be at least 100 gigabytes (GB). Any discrepancy between the composite CI being analyzed and attribute values specified by the compliance rule indicates a breach of the compliance rule.

A compliance rule is represented by general rule properties and a definition of the compliance rule. The general rule properties include, as examples, a name of the compliance rule, a description of the compliance rule, views that are to be examined, and the period of time over which the validation against the compliance rule is to be performed. A “view” refers to a collection of configuration items that relate to a particular system or service (e.g., e-mail service, web service, storage system, etc.).

The definition of the compliance rule contains, as examples, a configuration item type, a filter, and a baseline configuration item hierarchy. The configuration item type represents the type of configuration item whose compliance is to be examined. Configuration items of types that are not the same as the configuration item type are filtered out as not being relevant for comparison. For example, when checking the configuration of web servers, the configuration type would be web server, and any other configuration items that are not web servers would not be compared to the compliance rule.

The filter provides a finer way of filtering configuration items that are to be compared to the baseline configuration item hierarchy. The filtering can be performed by using a topological query, such as a query according to the Topology Query Language (TQL). A TQL query filters topology configuration items according to their attributes and links. Typically, a TQL query is submitted to a configuration management database (CMDB), which is a repository of information relating to the components of an IT system. The TQL query can specify a reduced set of configuration items to be examined. For example, the TQL query can specify that the configuration management system is to only examine Java-based application servers, so the configuration item type section of the compliance rule definition would indicate the type as being “application server,” while the filter section of the compliance rule definition can use a TQL query to filter out non-Java-based application servers.

The baseline configuration item section of the compliance rule definition defines the structure of the configuration items that are to be used in performing a comparison to a composite CI that is being analyzed. The baseline configuration item hierarchy defines the structure that the composite CI should have, and the attribute values that are to be associated with each configuration item of the composite CI.

FIG. 2 also shows that the composite CI compliance module 102 has a graphical user interface (GUI) module 120, which is able to present at least one GUI screen according to some embodiments for performing definition of a compliance rule 114 and to define comparisons between the compliance rule 114 and a composite CI 112 being analyzed. The GUI screen(s) presented by the GUI module 120 can be displayed by a display device 124. Video data for display by the display device 124 is provided through a video controller 122 that is connected to the processor(s) 108.

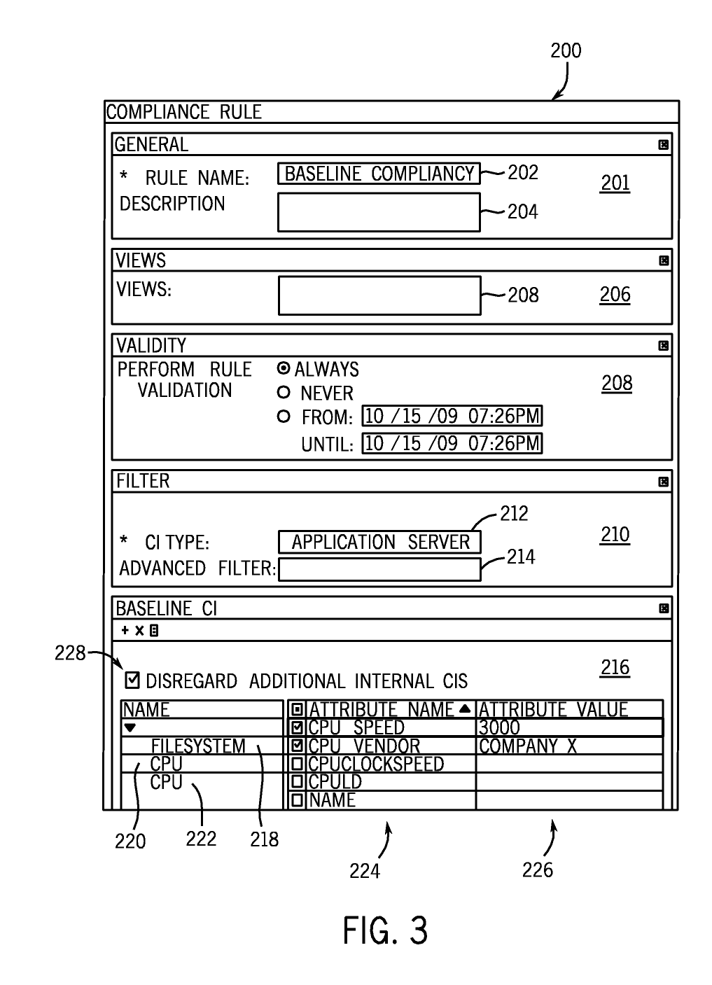

FIGS. 3-5, which are discussed below, depict various examples of GUI screens presentable by the GUI module 120. Note that the details of these GUI screens are provided as examples—other implementations can use further or alternative details in the GUI screens.

FIG. 3 illustrates an example GUI screen 200 (provided by the GUI module 120 of the configuration management system 100 of FIG. 2) for defining a compliance rule according to some implementations. A general properties section 201 of the GUI screen 200 includes a first field 202 for the compliance rule name and a second field 204 for entering text relating to a description of the compliance rule. A views section 206 specifies views of interest that can be entered into a field 208. As noted above, a view refers to a collection of configuration items that relate to a particular system or service. The views specified in the views section 206 identify those views that the compliance rule defined by the GUI screen 200 is to be applied against.

A validity section 208 contains selectable items indicating when validation based upon the compliance rule defined by the GUI screen 200 is to be performed. For example, the “Always” selector is selected in the example of FIG. 3, which indicates that the compliance rule being defined by the GUI screen 200 should always be validated. Other possible selectors in the validity section 208 includes “Never” or some definable time interval (starting at a first date and time and ending at a second date and time).

A filter section 210 contains a first field 212 to specify the configuration item type whose compliance is to be examined (in the example shown, the configuration item type is “Application Server”). Another field 214 in the filter section 210 provides advanced filtering, such as by using a topological query as discussed above.

A baseline configuration item hierarchy section 216 allows the user to specify attribute values for the various configuration items of the baseline configuration item hierarchy. In the example of FIG. 3, the configuration items of the baseline configuration item hierarchy include a file system configuration item (218) and two CPU configuration items (220, 222). In the example of FIG. 2, the CPU configuration item 220 has been highlighted (selected) by a user, such that the attributes of the CPU configuration item 220 are listed (at 224) in the section 216. The depicted example attributes of the CPU configuration item 220 include CPU speed (which in the example of FIG. 2 has a value of 3000 GHz), a CPU vendor (which in the example of FIG. 2 has a value of company X), a CPU clock speed, a CPU ID, and a name of the CPU. The values associated with the attributes listed at 224 are provided in portion 226 in the baseline configuration item hierarchy section 216 of FIG. 3.

When specifying attribute values in portion 226 in the section 216 of FIG. 2, a list of candidate values can be presented to a user from which the user can make a selection (or alternatively, the user can manually enter the attribute value). For example, suggested values list can be provided for user selection. The suggested values list can also present statistics relating to the attribute values from various existing views.

The compliance rule as defined using the GUI screen 200 can enforce an exact composite CI structure (e.g., a host with exactly two CPUs and exactly one disk drive), or the compliance rule can be defined to enforce only minimal specifications (e.g., host with at least two CPUs and at least one disk drive). The minimal specifications can be specified by checking a box 228 in the section 216 of the GUI screen 200 for disregarding additional internal CIs of the composite CI that is under analysis. Disregarding additional internal CIs means that the presence of the additional internal CIs would not cause violation of the compliance rule.

With the GUI screen 200, a user can create or modify a compliance rule for comparing against a composite configuration item.

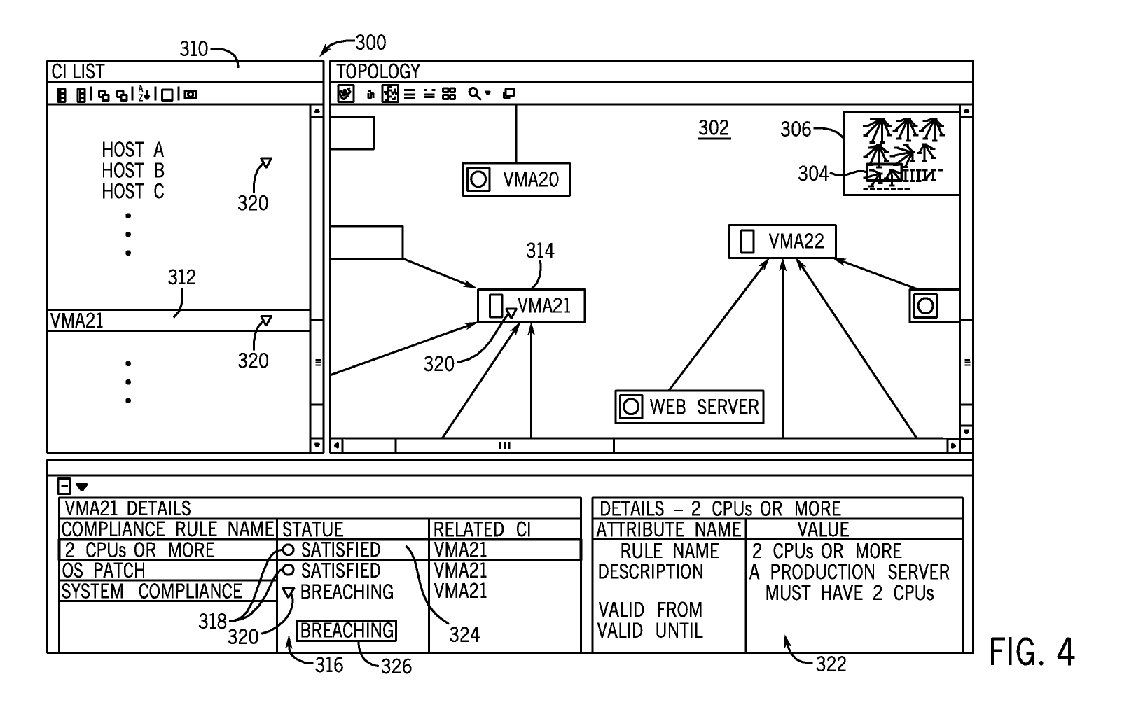

As noted above, the compliance rule is applied against configuration items of views identified in the views section 206 in FIG. 3. A portion of an example topology of a view is depicted in a GUI screen 300, as shown in FIG. 4. A topology view section 302 of the GUI screen 300 represents a portion 304 of the overall view topology represented in a box 306. Each icon (represented as a generally rectangular box) in the topology view section 302 represents a composite CI. The view represented in the box 306 thus includes a collection of interconnected composite CIs. The relevant composite CIs (those composite CIs of the configuration item type specified in field 212 and that satisfies the fitter section 214 of FIG. 3) in the view are compared against the baseline configuration item hierarchy (and associated attributes) as discussed above. The validation result is marked on each such relevant composite CI, and can be viewed later when the view is displayed, such as in the example of FIG. 4.

The GUI screen 300 includes a CI list section 310 to list the composite CIs contained in the view depicted in the GUI screen 300. Several example composite CIs are listed in the CI list section 310. A composite CI named “VMA21” (312) in the list section 310 has been highlighted to view details associated with the VMA21 composite CI. The VMA21 composite CI 312 is also represented as an icon 314 in the topology view section 302 of the GUI screen 300.

Since the VMA21 composite CI 312 has been highlighted, the details of whether the VMA21 composite CI 312 satisfies at least one compliance rule are presented in a result section 316 of the GUI screen 300. The left-most column of the results section 316 lists compliance rules that have been compared to the VMA21 composite CI 312. The three example compliance rules listed include the following: “2 CPUs or more”; “OS patch”; and “System compliance.” The second column of the result section 316 indicates whether the respective compliance rule has been breached or satisfied by the VMA21 composite CI 312. The circle symbols 318 in the status column of the result section 316 indicates that the corresponding compliance rules (“2 CPUs or more” and “OS patch”) are satisfied by the VMA21 composite CI 312. On the other hand, a triangle symbol 320 indicates that the third compliance rule (“System compliance”) has been breached—in other words, the VMA21 composite CI 312 does not satisfy the “System compliance” rule. The third column of the result section 316 identifies the composite CI (VMA21 composite CI) that is the subject of the result section 316.

Note that the triangle symbol 320 is also shown in the CI list section 310 of the GUI screen 300 in association with the VMA21 composite CI 312, as well as in the icon 314 corresponding to the VMA21 composite CI. Another triangle symbol 320 is also associated with the Host B composite CI in the CI list section 310, to indicate that the host B composite CI has also breached a compliance rule. Upon seeing such an indication of breach (using the symbol 320), a user can click on the corresponding composite CI (such as in the CI list section 310 or in the topology view section 302), to look at details of the breach in the result section 316. If a composite CI in the GUI screen 300 is not associated with either the circle symbol 318 or triangle symbol 320, then that is an indication that the composite CI has not yet been analyzed with respect to a compliance rule.

A details section 322 in the GUI screen 300 is also provided to depict details regarding a compliance rule of interest, which in this example is the “2 CPUs or more” compliance rule. As shown in FIG. 4, the “2 CPUs or more” compliance rule has been highlighted (at 324) in the result section 316, causing the details of the “2 CPUs or more” compliance rule to be shown in the details section 322. The various attributes of the “2 CPUs or more” compliance rule are shown in the details section 322. Selection of another compliance rule in the result section 316 would cause the details of the other compliance rule to be depicted in the details section 322.

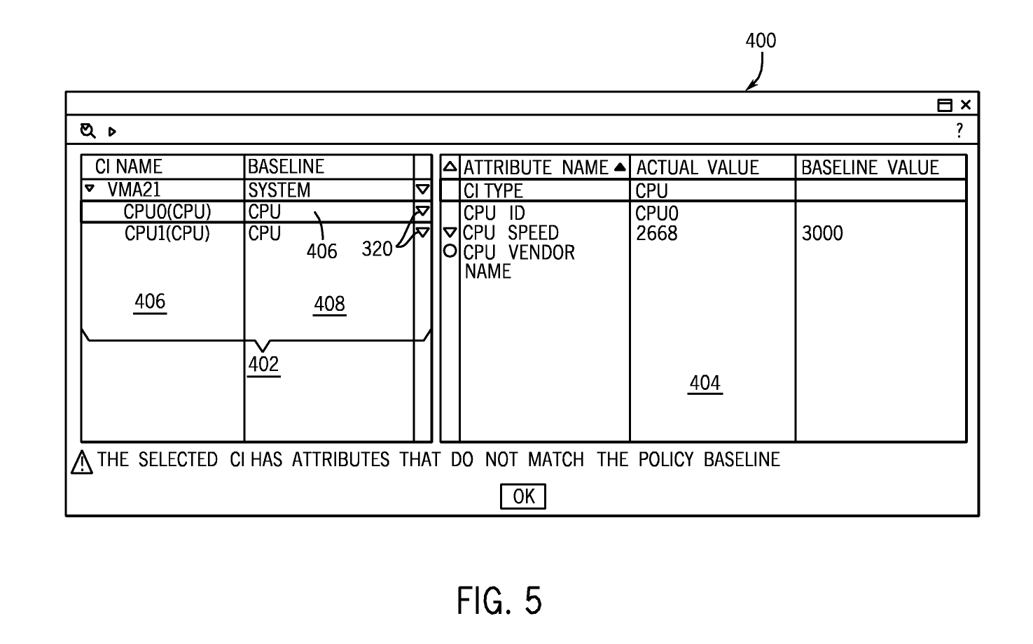

As further shown in FIG. 4, in the result section 316, a selectable breach icon 326 is presented to allow a user to make a selection to view further details regarding the reasons for a breach. Upon user double-clicking (or other selecting action) of this “breach” icon 326, an example GUI screen 400 as shown in FIG. 5 can be invoked. In FIG. 5, a first section 402 of the GUI screen 400 lists in a first column 406 the configuration items of the composite CI being analyzed (which in this example is VMA21) along with the corresponding configuration items of the baseline configuration item hierarchy (which in this example is “System”) in a second column 408. In the VMA21 composite CI, the configuration items include a CPU0 configuration item and a CPU1 configuration item, which correspond to CPU configuration items in the “System” baseline configuration item hierarchy. As indicated by the symbols 320 shown in the first section 402 of the GUI screen 400, both the CPU0 and CPU1 configuration items of the VMA21 composite CI have breached the corresponding specifications of the CPU configuration items in the “System” baseline configuration item hierarchy.

A second section 404 of the GUI screen 400 shows further details regarding why a highlighted (406) one of the CPU0 and CPU1 configuration items has breached the corresponding compliance rule. In FIG. 5, the CPU0 configuration item has been highlighted (406) in the first section 402.

As depicted in the second section 404, the violation is caused by the CPU speed of CPU0 having a value (2668) that is less than the baseline value (3000)—in other words, the CPU speed of CPU0 is too slow.

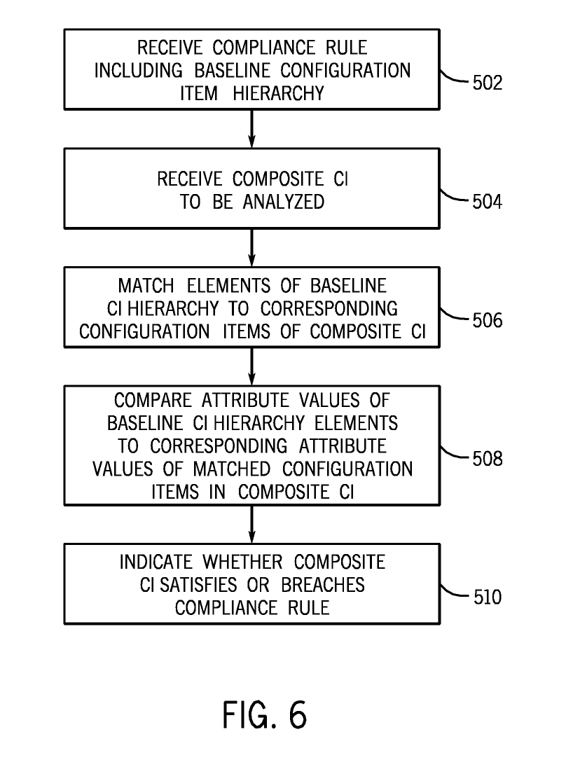

FIG. 6 is a flow diagram of a process performed by the configuration management system 100 (including the composite CI compliance module 102) of FIG. 2, in accordance with further embodiments. In some implementations, the process of FIG. 6 can be performed as an offline process (offline from operational aspects of the system including IT components). The process of FIG. 6 can be performed at intermittent intervals or in response to received events. A compliance rule is received (at 502) where the compliance rule includes a baseline configuration item hierarchy in some embodiments. The received compliance rule can be based on user selections made in a GUI screen, such as in the GUI screen 200 shown in FIG. 3.

A composite CI to be analyzed is also received (at 504). The composite CI to be analyzed can be part of an overall service that includes linked composite CIs. Analyzing a composite CI starts by matching the structure of the composite CI's hierarchy to the hierarchy of the baseline configuration item. Matching elements of the baseline configuration item hierarchy to corresponding configuration items of the composite CI (as performed at 506) is provided by the matching module 104 in the composite CI compliance module 102 shown in FIG. 2.

Next, the attribute values of the baseline configuration item hierarchy elements are compared (at 508) to corresponding attribute values of matched configuration items in the composite CI (by applying the comparison module 106 of FIG. 2). Based on the comparing, an indication is provided (at 510) whether the composite CI satisfies or breaches the compliance rule.

Upon detection of a breach, the configuration management system 100 can provide a breach indication by sending a notification to the remote configuration manager 118 (FIG. 2) or to some other entity. The notification can be in the form of an email or some other report. Alternatively, the configuration management system 100 can automatically perform corrective actions to address the breach that has been detected. The corrective actions can be based on a predefined procedure or predefined rules stored in the configuration management system 100.

The matching module 104 and composition module 106 applied at 506 and 508 are discussed further below. The matching module 104 determines which configuration item of the composite CI (to be analyzed) should be compared to which configuration item of the baseline configuration item hierarchy. As shown in FIG. 7, an example composite CI to be analyzed is a host that has three file systems (C, D, E). On the other hand, an example baseline configuration hierarchy only has two file systems (file system 1 and file system 2). The matching module 104 has to decide how the file systems in the host that is to be analyzed should be matched to the file systems of the baseline.

The matching module 104 first matches the type of each configuration item defined in the baseline configuration item hierarchy to the composite CI's hierarchy. If there is only one instance of that type in both hierarchies (e.g., the analyzed host has only one CPU and the baseline host has only one CPU), then those configuration items are marked as matching. However, if there are a few instances of the configuration item type, the matching module 104 tries to match the configuration items using some attributes that are marked as matchable attributes. For example, the configuration items of type “File System” may be configured to be matched based on their manufacturers, based on their size, or based on other attributes. As another example, the matching can be first performed based on manufacturer, and then according to size. Matched items are collected as pairs.

Each of the matching attributes can be assigned a weight. Attributes that are defined in the matching configuration are weighted according to their priorities, such as by using the following 2ⁿ, where n represents the priority of the corresponding matching attribute. The weight of other attributes that are not defined in the matching configuration is assigned a value 1, for example.

The score of each configuration item is the sum of all the weights of the matching attributes which have values equal both in the analyzed configuration item and in the baseline configuration item. In one example, a greedy algorithm can be used to choose the highest score.

Items that cannot be compared by the matching module 104 are marked as breaching the compliance rule (for example, a host being analyzed has three file systems, while the baseline states that there should only be two). However, if the baseline configuration item hierarchy specifies a minimal requirement, then no breach would occur if the host being analyzed has more file systems than the baseline host.

Once pairs of configuration items are identified (where a pair of configuration items includes a configuration item from the composite CI being analyzed and a corresponding configuration item from the baseline configuration item hierarchy), a comparison can be performed by the comparison module 106. The comparison module 106 compares the values of the attributes of the paired configuration items and checks for any discrepancies of attribute values. If any discrepancy is found, then the configuration item of the composite CI being analyzed is marked as breaching, such as by using the triangle symbol 320 shown in FIGS. 4 and 5.

Comparison of attribute values of configuration items in each pair can be based on any at least one of the following operators:
(1) Equal: the checked attribute value (of the configuration item of the composite CI being analyzed) should be identical to the compared baseline value;
(2) Greater than: the checked value should be greater than the compared baseline value;
(3) Lower than: the checked value should be lower than the compared baseline value;
(4) Between range: the checked value should be between the compared range;
(5) Percentage deviation: the checked value can deviate from the compare value within a defined percentage range and still be considered as equal (e.g., a checked CPU speed can be ±10% of 3000 MHz).

By using some embodiments, improved enforcement of an enterprise's policies (as reflected in the compliance rules) can be achieved. Sophisticated matching and comparison techniques can be used, which are able to discover discrepancies between attribute values as well as discrepancies in the number of configuration items in the composite CI not matching the number defined in the baseline configuration item hierarchy. Compliance rules can be easier to define as they do not involve creation of complex TQL queries against a CMDB. Moreover, the GUI provided by some embodiments is more intuitive and can service a wider range of users without users having to have a deep and thorough knowledge of the CMDB.

A compliance rule can be easier created based on an already existing composite CI that is known by a user to be compliant. It is easier to identify which values should be assigned to attributes in an environment that is mostly compliant. For example, this can be accomplished by presenting statistics of compliant values for attributes. By performing compliance validation on a composite CI, the compliance checking is made less complex since a user does not have to enforce compliance on individual configuration items. The GUI screens presented by the configuration management system 100 according to some embodiments allows for relatively easy identification of the cause of a breach and the configuration item that resulted in the breach. Symbols or other indicators can direct the user's attention to which configuration items are in breach, and the user can make selections in GUI screens to view further details of the breach(es).

Machine-readable instructions described above (including the composite CI compliance module 102 of FIG. 2) are loaded for execution on at least one processor (e.g., 108 in FIG. 2). A processor can include a microprocessor, microcontroller, processor module or subsystem, programmable integrated circuit, programmable gate array, or another control or computing device.

Data and instructions are stored in respective storage devices, which are implemented as one or plural computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or computer-usable storage medium, or alternatively, can be provided on multiple computer-readable or computer-usable storage media distributed in a large system having possibly plural nodes. “Storage media” is intended to either a singular storage medium or plural storage media. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, through a user interface, at least one selection relating to at least one element of a compliance rule for a composite configuration item, wherein the composite configuration item comprises a collection of configuration items that are related to each other, and wherein each of the configuration items represents a configuration of an information technology component; and
determining, by a computer system, whether the composite configuration item satisfies the compliance rule, the elements of the compliance rule being compared to the corresponding configuration items of the composite configuration item as part of the determining.

2. The method of claim 1, wherein receiving the at least one selection relating to the at least one corresponding element of the compliance rule comprises receiving the at least one selection through a graphical user interface screen having user-selectable fields.

3. The method of claim 1, wherein receiving the at least one selection comprises receiving a selection relating to a type of composite configuration item to which the compliance rule is to be applied.

4. The method of claim 1, wherein receiving the at least one selection comprises receiving a filter to be applied for filtering composite configuration items that are to be compared to the compliance rule.

5. The method of claim 1, wherein receiving the at least one selection comprises receiving an indication of a time interval over which the compliance rule is to be applied to composite configuration items.

6. The method of claim 1, wherein receiving the compliance rule comprises receiving a baseline configuration item hierarchy that includes a hierarchical arrangement of configuration items.

7. The method of claim 6, wherein the baseline configuration item hierarchy is based on an existing composite configuration item that is known to be compliant with the compliance rule.

8. The method of claim 6, wherein the baseline configuration item hierarchy is manually created.

9. The method of claim 6, wherein comparing the elements of the compliance rule to the corresponding configuration items of the composite configuration item comprises comparing attribute values associated with the configuration items of the baseline configuration item hierarchy to corresponding attribute values of the configuration items of the composite configuration item.

10. The method of claim 9, further comprising:
matching, using a matching module, the configuration items of the baseline configuration item hierarchy to corresponding configuration items of the composite configuration item,
wherein the comparing comprises comparing the attribute values of the configuration items of the baseline configuration item hierarchy to attribute values of corresponding matched configuration items of the composite configuration item.

11. The method of claim 1, further comprising:
presenting a view of a topology of composite configuration items, wherein the composite configuration item compared to the compliance rule is part of the topology.

12. The method of claim 11, further comprising:
displaying, in the view, at least one indicator regarding which of the composite configuration items in the topology have breached the compliance rule.

13. The method of claim 12, further comprising:
receiving user selection of a particular one of the composite configuration items associated with at least one indicator; and
in response to receiving user selection of the particular composite configuration item, presenting in a result section of a graphic user interface (GUI) screen the compliance rule that has been breached by the particular composite configuration item.

14. The method of claim 13, further comprising:
displaying information regarding a reason for the breach of the compliance rule in the GUI screen.

15. A computer system comprising:
at least one processor; and
a composite configuration item compliance module executable on the at least one processor to:
receive a definition of a compliance rule that includes a baseline configuration item hierarchy having an arrangement of related configuration items;
compare configuration items of a composite configuration item to corresponding configuration items of the baseline configuration item hierarchy, wherein the composite configuration item includes an arrangement of related configuration items, and wherein each configuration item of the composite configuration item represents a configuration of an information technology (IT) component; and
based on the comparing, provide an indication of whether the composite configuration item has breached the compliance rule.

16. The computer system of claim 15, wherein the IT components corresponding to the configuration items of the composite configuration item include components selected from among:
an electronic device;
an electronic device portion;
a software component; and
a database component.

17. The computer system of claim 15, wherein the composite configuration item compliance module is executable on the at least one processor to further:
present a graphical user interface (GUI) screen having fields to receive the definition of the compliance rule, wherein the fields are selected from among a first field for identifying a type of composite configuration item subject to application of the compliance rule, a second field defining a filter specifying which composite configuration items are to be validated against the compliance rule, and a third field specifying a time interval during which the compliance rule is to be applied.

18. The computer system of claim 15, wherein the composite configuration item compliance module is executable on the at least one processor to further:
present a view of an arrangement of composite configuration items, wherein at least one indicator is associated with one of the composite configuration items in the view for indicating that the corresponding composite configuration has breached the compliance rule.

19. The computer system of claim 18, wherein the GUI screen is to further depict details regarding reasons for breach of the compliance rule.

20. An article comprising at least one computer-readable storage medium storing instructions that upon execution cause a computer system to:
receive, in fields of a graphical user interface (GUI) screen, a definition of corresponding elements of a compliance rule for a composite configuration item, wherein the composite configuration item comprises a collection of configuration items that are related to each other, wherein each of the configuration items represents a configuration of an information technology component, and wherein the compliance rule is a baseline composite item hierarchy having a hierarchy of configuration items; and
determine whether the composite configuration item satisfies the compliance rule, wherein the determining comprises:
matching the configuration items of the composite configuration item to corresponding configuration items of the baseline composite item hierarchy; and
comparing attribute values of the configuration items of the composite configuration item to attribute values of corresponding matched configuration items of the baseline configuration item hierarchy.
